(19) United States
(12) Patent Application Publication
(10) Pub. No.: US 2024/0333022 A1
(43) Pub. Date: Oct. 3, 2024

(54) Thermoelectric System for Charging Lithium Batteries

(71) Applicant: Mark Dickson, Orangeburg, SC (US)

(72) Inventor: Mark Dickson, Orangeburg, SC (US)

(21) Appl. No.: 18/624,044

(22) Filed: Apr. 1, 2024

Related U.S. Application Data
(60) Provisional application No. 63/456,467, filed on Apr. 1, 2023.

(51) Int. Cl. H02J 7/35; H01M 10/052

(52) U.S. Cl. CPC H02J 7/35; H01M 10/052

(57) ABSTRACT

A self-driving type direct energy conversion system capable of suppressing global warming by using a thermoelectric element, a solar power source, either a parabolic reflecting system to create a hot spot, or solar panels, to create energy to recharge lithium batteries by capturing solar energy with the use of thermoelectric components and then transferring the energy to lithium battery charging stations through a large electric storage system and an electric dispensing system which goes to the lithium battery recharging stations.

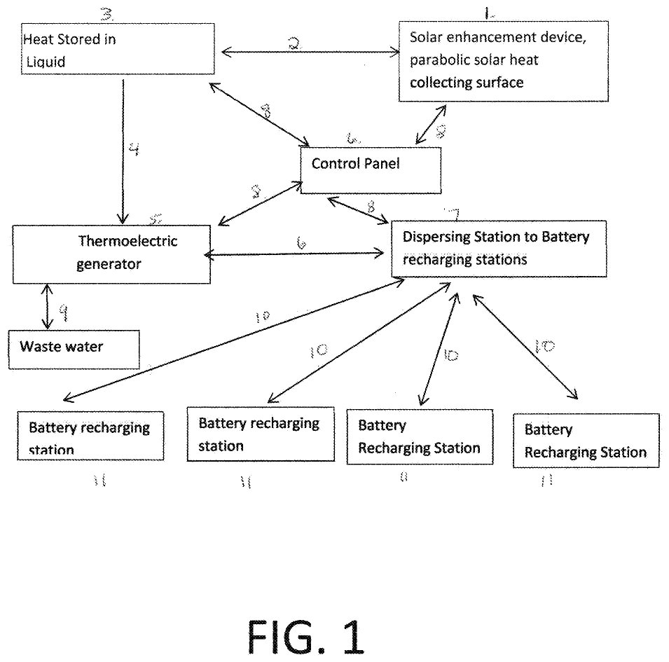

### FIELD OF THE INVENTION

Solar powered thermoelectric charging station for lithium batteries.

### BACKGROUND

Thermoelectric power generation is a promising alternative technology for the electricity production in the future because of no moving or mechanical elements, low O&M costs or their long lifespan. This application presents a new development in energy technology, energy economics and energy operation. The system of this application combines the use of thermoelectric generators with solar power creating the heat and a electric power storage facility, and converter to transfer the energy to a lithium battery, with a control panel to optimize the operation.

In the past thermoelectric systems have been considered inefficient comparing to other electricity generation technologies, but they constitute an attractive technology especially for stand-alone power systems, especially in home or industrial applications, or where a small electric substation is required application. Thermoelectric systems store energy in liquid, releasing the heat back to the heat transfer material (the thermos electric power generator) to provide power when needed. There have not been any attempts to use thermoelectric power generators to recharge lithium batteries.

### Principals of Operation

The thermoelectricity is the phenomenon based on the thermoelectric effect, which can convert heat, which is supplied by solar panels, or a solar parabolic reflector, into electricity using a temperature difference between both sides of a thermoelectric material. Thermoelectric generators are based on two thermoelectric semiconductors with conducting plates on the top (absorbing heat from solar power) and the bottom (a cold plate without access to the solar power, When a temperature difference is applied between the hot and cold conducting plates, holes and electrons start accumulating on the cold side, creating an electric field between the two sides of each semiconductor, this current is then used through a convertor, or dispenser, or directly to a lithium battery. The thermoelectric semiconductor material must have high electric conductivity but low thermal conductivity to get a high temperature difference between the two sides of the device ensuring a good performance.

### SUMMARY OF THE INVENTION

A battery charging system comprising (a) a source of solar power to provide heat, either solar panels or a parabolic heat collector made of silicon or other material to concentrate, a liquid storage device that can store hot liquid, which is sent to the thermoelectric unit on demand, this also allows power to be generated when the sun is not shining, b) a conduit to send heat to the hot liquid storage facility, c) a conduit to send heated liquid to the thermoelectric device, (d) a thermoelectric device composed of thermal material which have high electric conductivity and low thermal conductivity, (e) a hot plate in the thermoelectric device, (f) a cold plate in the thermoelectric device, e and f together producing electricity, (g) potentially a converter box, though that may not be necessary in some systems, (h) a control panel, (i) a distribution system to send electricity to (j) at least one charging circuit to charge at least one rechargeable battery cell.

### Other Configurations

The hot liquid storage can be replaced by battery storage, in this case the thermoelectric generator would take hot air from the solar enhancement device and convert it to electricity and then send it to the battery storage, which would send electricity to the dispersing station on demand.

Pumps could be added to the hot air conduit from the solar enhancement area and water pumps could be added in the conduit from the heated liquid storage to the thermoelectric generator. The hot air going to heat the liquid aspect of the invention could be replaced with a system where the solar panels or parabolic reflector heat water which is then stored in the hot liquid storage.

### DESCRIPTION OF THE DRAWING

The control panel 6 controls activity of the four major components, it is connected to those components through electric wire conduits 8:
The parabolic solar heat collector 1;
The heated liquid storage facility 3;
The thermoelectric generator 5;
The dispersing system, 7 which may include a converter box, sending electricity to the electric battery recharging stations 11.

The conduit to the heated liquid storage area 3 from the solar enhancement device 1 is a hot air conduit 2.

The conduit from the heated liquid storage 3 to the thermoelectric generator 5 is a hot water pipe 4.

The conduit from the thermoelectric generator 5 to the dispersing station 7 is an electric wire 6.

The conduit from the dispersing station 7 to the individual batter recharging stations 11 is an electric wire 10.

The conduit from the thermoelectric generator 5 to the waste water outlet 9 is a water pipe, waste water is passed out of the system with a water pipe.

I claim:

1. A thermoelectric system for charging lithium batteries comprising:
a parabolic heat collector made of silicon or other material to concentrate heat;
a hot air conduit to send heat from the parabolic reflector to a heated liquid storage;
a hot liquid conduit that sends heated liquid to the thermoelectric unit on demand;
a second hot liquid conduit that sends hot liquid to the waste water outlet;
an electric wire that send electricity from the thermoelectric generator to the dispersing station;
electric wires that send electricity from the dispersing station to at least one battery charging station;
a control panel with individual electric wires to the parabolic reflector, the heated liquid storage, the thermoelectric generator and the dispersing station.

2. The system of claim 1 where the wire communication system is replaced with a wireless communication system.

3. The system of claim 1 where the parabolic solar collector is replaced by solar panels.

4. The system of claim one where the dispersing station also contains a converter to change the electricity from the thermoelectric unit to usable energy for the battery charging stations.
